(19) United States
(12) Patent Application Publication
(10) Pub. No.: US 2018/0034852 A1
(43) Pub. Date: Feb. 1, 2018

(54) ANTI-SPOOFING SYSTEM AND METHODS USEFUL IN CONJUNCTION THEREWITH

(71) Applicant: ISITYOU LTD., Lod (IL)

(72) Inventor: Shmuel GOLDENBERG, Ness Tziona (IL)

(21) Appl. No.: 15/531,229

(22) PCT Filed: Nov. 24, 2015
(86) PCT No.: PCT/IL2015/051135

§ 371 Date: May 26, 2017

Related U.S. Application Data
(60) Provisional application No. 62/084,587, filed on Nov. 26, 2014.

(51) Int. Cl. H04L 29/06

(52) U.S. Cl. CPC H04L 63/1483; H04L 63/1416; H04L 63/0861

(57) ABSTRACT

An anti-spoofing system operative for repulsing spoofing attacks in which an impostor presents a spoofed image of a registered end user, the system comprising a plurality of spoof artifact identifiers including a processor configured for identifying a respective plurality of spoofed image artifacts in each of a stream of incoming images and a decision maker including a processor configured to determine an individual image in the stream is authentic only if a function of artifacts identified therein is less than a threshold criterion.

### REFERENCE TO CO-PENDING APPLICATIONS

Priority is claimed from 62/084,587, entitled “Oscillating Patterns Based Face Anti-Spoofing Approach Against Video Replay” and filed 26 Nov. 2014.

### FIELD OF THIS DISCLOSURE

The present invention relates generally to and more particularly to authentication and particularly user authentication for device, application, and account access and for authorization of mobile payments and other sensitive communications.

### BACKGROUND FOR THIS DISCLOSURE

Uncountable numbers of operations have gone mobile, such as but not limited to mobile payments accepted by online banks and payment processors as well as telecommunication, travel, insurance and gaming enterprises.

The term “mobile” as used herein is intended to include but not be limited to any of the following: mobile telephone, smart phone, playstation, iPad, TV, remote desktop computer, game console, tablet, mobile e.g. laptop or other computer terminal, embedded remote unit.

Certain state of the art facial recognition technology and face data sets are described at a Justin Lee article, dated 19 Mar. 2015, posted at the following www link: biometricupdate.com/201503/google-claims-its-facial-recognition-system-can-achieve-near-100-percent-accuracy. The data repository referred to includes for the most part, full front images in controlled, e.g. completely flooded, lighting, some of which are post-processed e.g. using Photoshop.

IsItYou's website, including the company's presentation at TechCrunch Disrupt 2014 in San Francisco, describe how IsItYou's technology compares favorably with state of the art technologies.

Spoofing includes malicious attempts to impersonate a legitimate user. For example, an impostor may download a picture of a registered user, John Smith, from the Web, and use the picture, on a tablet or on a 2d-printed page, to impersonate John. An impostor may also print a 3d mask of John's face.

A European research project called Tabula Rasa is working on anti-spoofing for biometrics.

Google and others use facial recognition to authorize mobile device users' access from an initial lock screen. Google required end users to blink on command. However, video spoofs may include enough blinks to falsely reassure Android's facial recognition that a bona fide end user has blinked as commanded.

Generally, conventional spoof detection has included four categories: a) challenge response based methods requiring user interaction, b) behavioral involuntary movements detection for parts of the face and head, c) data-driven characterization, and d) presence of special anti-spoofing devices. In particular, Local Binary Patterns (LBP) and concentric Fourier based features have been used for video data.

The methods from a) require some simple facial movements, such as blinking or smiling.

The closest of the above prior art methods is believed to be:
A. da Silva Pinto, H. Pedrini, W. R. Schwartz, and A. Rocha, “Video-Based Face Spoofing Detection through Visual Rhythm Analysis”, SIBGRAPI '12 Proc. of the 2012 25th SIBGRAPI Conference on Graphics, Patterns and Images, pp. 221-228, 2012.

Vulnerability of current commercial FR (face recognition) systems against spoofing attacks was tested in the spoofing challenge competition at the ICB 2013 event. A competition on counter measures to 2D facial spoofing attacks was also launched at ICB 2013. The spoofing attack issue for various biometrics (face, iris, fingerprint, gait, etc.) is a theme for the FP7 funded project TABULA RASA.

The disclosures of all publications and patent documents mentioned in the specification, and of the publications and patent documents cited therein directly or indirectly, are hereby incorporated by reference.

### SUMMARY OF CERTAIN EMBODIMENTS

Certain embodiments seek to prevent mobile related fraud, estimated to cause billions of dollars of damage.

Certain embodiments seek to provide anti-spoofing functionality which may include detecting (e.g. by differentiating an imaged live human face from an imaged impostor or otherwise determining whether a real person is in front of the camera or not) and responding to various spoofing attempts (e.g. by rejecting the impostor).

Certain embodiments seek to provide face recognition that takes into account effects that lighting has on an end user's face being imaged. For example, light diffracts from a tablet or printed photo differently relative to light bouncing off a real face e.g. because a printed photo or tablet are both flat whereas a face (or a 3D printer-generated mask of an end-user's face) is not.

Certain embodiments seek to provide facial recognition with a false-negative rate of just a few, e.g. 2 or 3 false negatives per 10,000 tasks as opposed to certain conventional face recognition systems which fail 2 or 3 times out of ten.

Certain embodiments seek to provide anti-spoofing functionality for hundreds of models of smartphones which vary in terms of operating system, camera, sensor, automatic gain control and so on. Also, each end user of each of these models uses her or his phone slightly differently relative to other users and relative to her or his own user at different times e.g. in terms of her or his pose (holding the phone at waist level, or to the side, etc.).

According to certain embodiments, a system and method for face antispoofing against video replay spoofing using oscillating patterns, is provided.

Typically, an automatic face authentication (FA) procedure begins with a data (facial images) acquisition procedure that can be carried out with or (in unconstrained settings) without human monitoring, the subsequent steps being automatically processed. When human monitoring of acquisition is absent (e.g. the system is operating in the “wild”/in an unsupervised setting), conventional FA systems can be easily cheated by spoofing identities: George, an impostor, can use photographs or recorded video playback containing a genuine representation of John, a registered user. A method for identifying spoof attacks when a video recording of a genuine user is played back in front of a FA system, is described herein, including detecting a specific image artifact such as oscillating patterns.

Smooth image areas are first identified in the pixel domain as containing potential oscillating-like patterns.

Next, image statistics are extracted and corresponding feature vectors are formed.

Eventually, these feature vectors are classified as real or attack feature vectors e.g. using Lagrangian Support Vector Machines (LSVMs).

At least the following embodiments may be provided:

Embodiment 1. An anti-spoofing system operative for repulsing spoofing attacks in which an impostor presents a spoofed image of a registered end user, the system comprising:
a plurality of spoof artifact identifiers configured for identifying a respective plurality of spoofed image artifacts in each of a stream of incoming images; and
a decision maker configured to determine an individual image in the stream is authentic only if a function of artifacts identified therein is less than a threshold criterion.

Embodiment 2. A system according to any preceding Embodiment wherein the function of artifacts comprises the number of artifacts identified.

Embodiment 3, A system according to any preceding Embodiment wherein the artifact identifier includes a heuristic gradient detector operative to detect at least one heuristic typical of spoof attempts.

Embodiment 4. A system according to any preceding Embodiment wherein the artifact identifier includes proximity detection.

Embodiment 5. A system according to any preceding Embodiment wherein the artifact identifier includes a luminosity analyzer configured to map image luminosity distribution and to identify an artifact based on previously learned statistics regarding image luminosity distribution.

Embodiment 6. A system according to any preceding Embodiment wherein the artifact identifier includes a Learning Block operative to learn a pattern of spoof attempts and capable to predict the next attempt type based on previously learned statistics.

Embodiment 7. A system according to any preceding Embodiment wherein the artifact identifier includes an oscillating pattern detector operative to map moiré patterns characteristic of video based spoofing attempts.

Embodiment 8. A system according to any preceding Embodiment wherein the threshold criterion stipulates that an individual image in the stream is authentic only if no (zero) artifacts are identified therein.

Embodiment 9. A system according to any preceding Embodiment wherein at least one spoof artifact identifier is configured to detect spoofed image artifacts present in plural images within a repository, in computer storage, of spoofed facial images.

Embodiment 10. A repository, in computer storage, of spoofed facial images generated using a mobile device to image a spoof of a human face rather than the human face itself.

Embodiment 11. A repository according to any preceding Embodiment which also includes facial images which are not spoofs.

Embodiment 12. A repository according to any preceding Embodiment which also includes facial images which are not generated using a mobile device.

Embodiment 13. A repository, in computer storage, of spoofed facial images generated by a mobile and other electronic devices.

Embodiment 14. A system according to any preceding Embodiment wherein at least some of the images are generated using a mobile device.

Embodiment 15. A system according to any preceding Embodiment wherein at least some of the images are generated by non mobile devices.

Embodiment 16. An anti-spoofing method operative for repulsing spoofing attacks in which an impostor presents a spoofed image of a registered end user, the method comprising:
Providing a plurality of spoof artifact identifiers configured for identifying a respective plurality of spoofed image artifacts in each of a stream of incoming images; and determining an individual image in the stream is authentic only if a function of artifacts identified therein is less than a threshold criterion.

Embodiment 17. A system according to any preceding Embodiment wherein the oscillating pattern detector is configured to: Identify smooth image areas which contain potential oscillating-like patterns and extract image statistics therefrom; Form corresponding feature vectors from the image statistics; and detect oscillating patterns by classifying feature vectors as real or attack feature vectors.

Embodiment 18. A system according to any preceding Embodiment wherein the oscillating patterns are detected using Lagrangian Support Vector Machines (LSVMs).

Embodiment 19. A computer program product, comprising a non-transitory tangible computer readable medium having computer readable program code embodied therein, the computer readable program code adapted to be executed to implement a method for anti-spoofing operative for repulsing spoofing attacks in which an impostor presents a spoofed image of a registered end user, the method comprising:
Providing a plurality of spoof artifact identifiers configured for identifying a respective plurality of spoofed image artifacts in each of a stream of incoming images; and

Determining an individual image in the stream is authentic only if a function of artifacts identified therein is less than a threshold criterion.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMS, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIGS. 1a-2, 4-6 are simplified flowchart illustrations useful in understanding certain embodiments.

FIG. 3 is an simplified flowchart illustration of a proximity detector operative to detect and crop a face and monitors its geometry relative to a pre-stored statistical model of a face.

FIG. 7 is a table showing comparative results including areas under curve (AUC), False Acceptance Rates (FAR). False Rejection Rates (FRR), and Half Total Error Rates (HTER).

FIG. 8 is an ROC curve for an example LSVM classifier corresponding respectively to an implementation of the method shown herein (represented by solid bold line), LPB (represented by dashdot line), and Concentric Fourier Features (CFOURF—represented by solid regular line).

Methods and systems included in the scope of the present invention may include some (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

A system and method which employs mobile device cameras to perform anti-spoofing in order to support face-based authentication of end user identities, is now described. The system may be used in addition to or instead of use of passwords, authentication questions, and other biometrics, such as but not limited to fingerprints.

According to certain embodiments, an Anti Spoofing processor is operative to detect, typically by inspecting only a single image frame, whether the key feature, e.g. face in the image frame, was or was not imaged directly from a live human; if so, the image is REAL (true, positively authenticated) and, if not, the image is deemed FAKE (false, not authenticated, negatively authenticated).

The Anti Spoofing processor typically comprises several anti-spoof functions such that each input image is typically analyzed by plural independent analyzing functions. Typically however, the functions are applied serially, and if any of the functions declares the image as FAKE, the test is stopped and the image is deemed FAKE without applying any additional functions.

All function blocks in the Anti Spoofing processor may be orthogonal and may be operative to analyze a certain aspect (artifact e.g.) of the image, with little, if any, overlap between the aspects analyzed by all other function blocks.

The functional blocks in the Anti Spoofing processor may for example include all, or any subset of, the following although other functional blocks may be used alternatively or in addition:

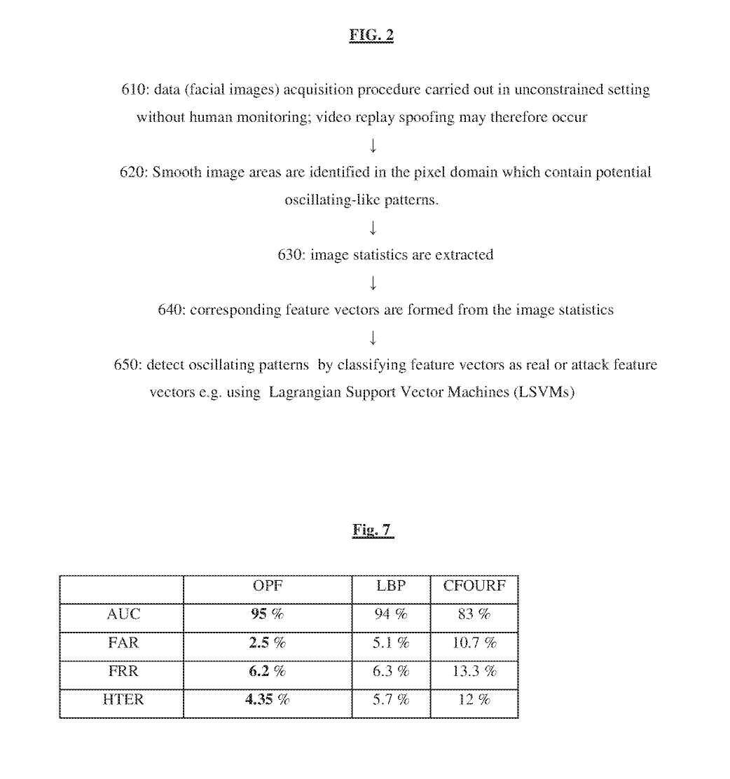

Oscillating patterns (FIG. 2 e.g.)

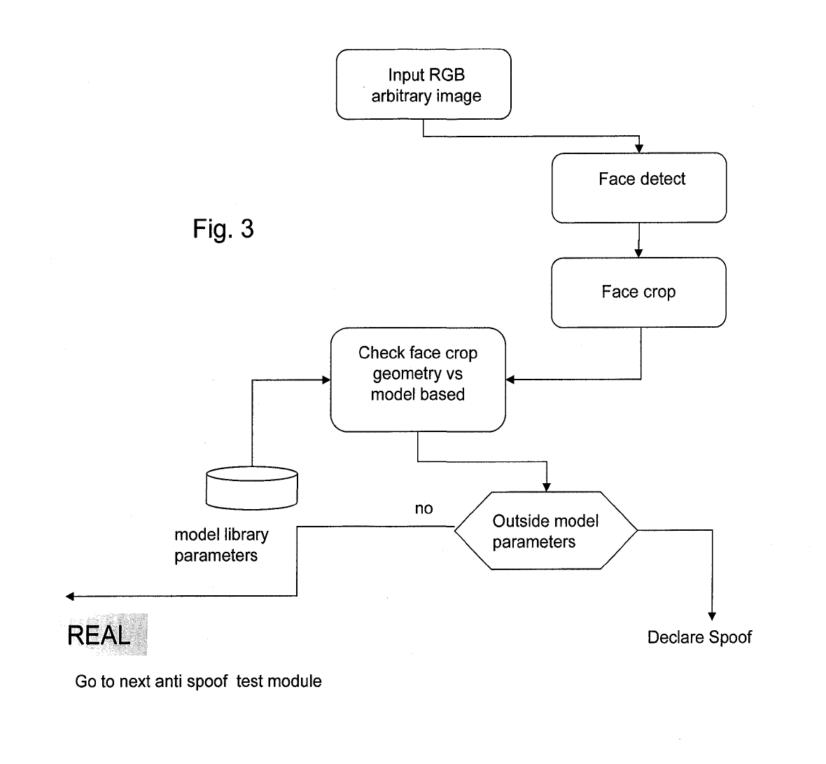

Proximity detection (FIG. 3 e.g.);

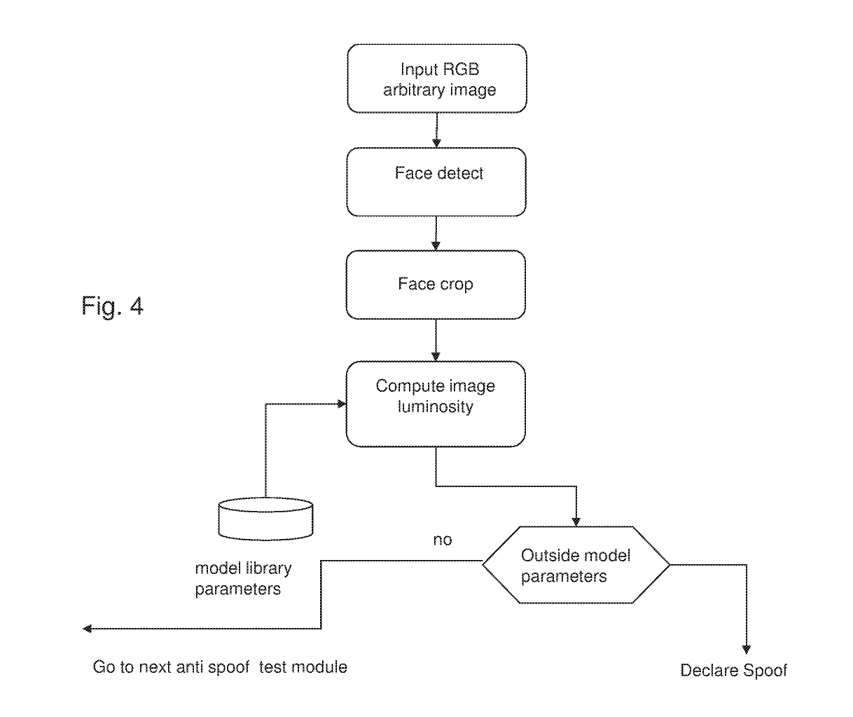

Luminosity analyzer (FIG. 4 e.g.);

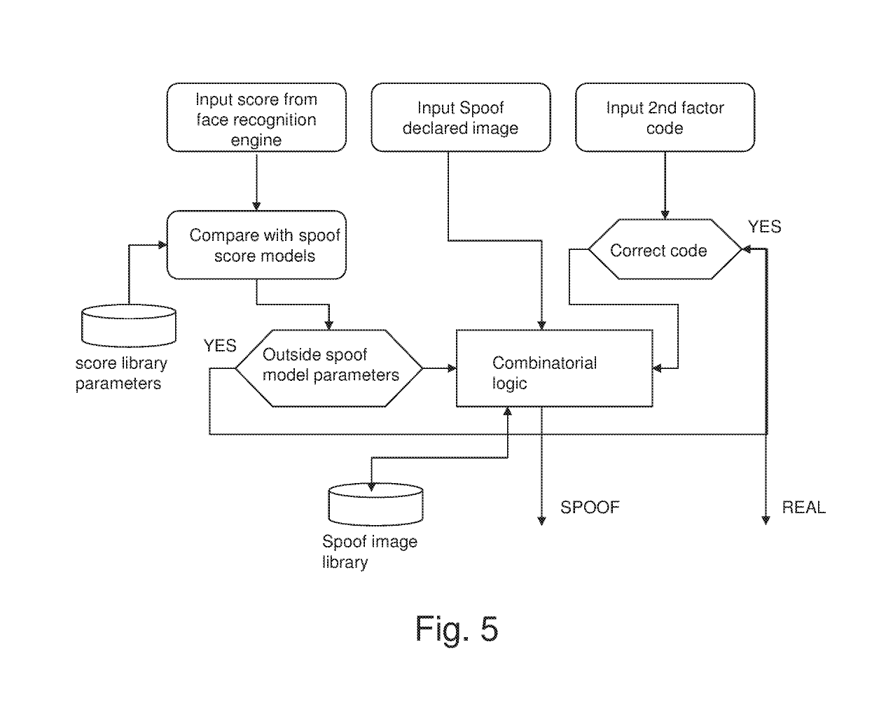

Learning Block (FIG. 5 e.g.);

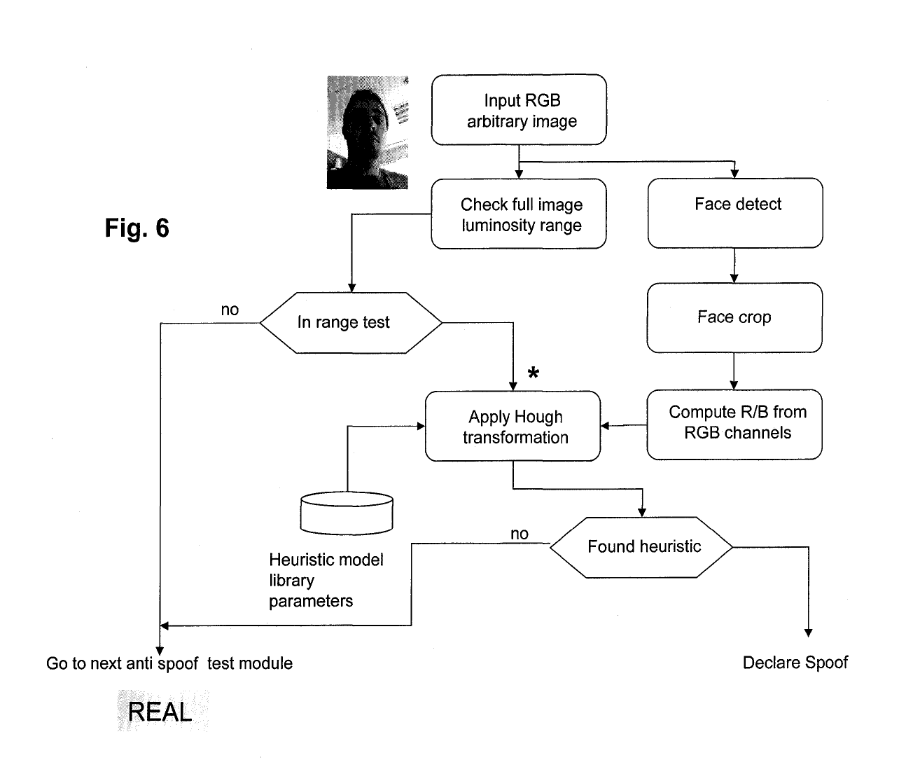

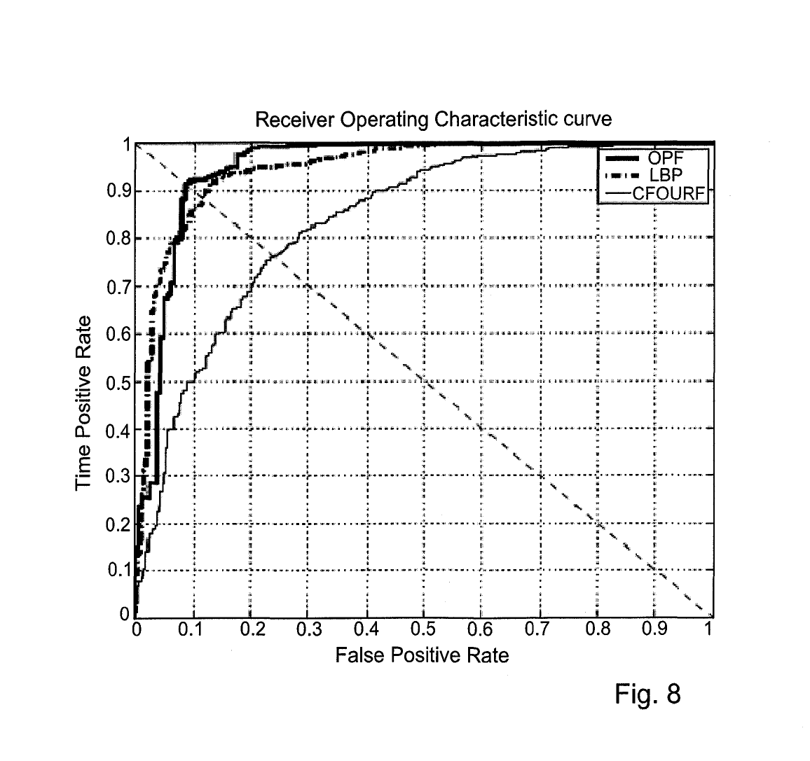

Heuristic gradient detector (FIG. 6 e.g.)

The Anti Spoofing processor typically assumes by default that each and every image to be analyzed is a FAKE other than those images which are specifically analyzed and determined to be REAL.

Functions may be selected and parameterized by inspection of a data repository of spoofed images including images generated by, preferably, any known attack devices it is desired to protect against, in any known relevant formats.

The Face Recognition processor typically comprises a comparison machine which is configured to compare two or more images and determine a similarity scale therebetween, e.g., as known in the art of facial recognition. A statistically predetermined threshold is then employed to determine true or false i.e. whether the face now presenting (test image) is or is not sufficiently similar to enrolled faces (reference images), to enable the presented face to be recognized as being the same as the enrolled face/s; it is appreciated that enrollment may comprise provision of 2-3 selfies rather than a single photograph of each individual to be identified.

Typically, some or all input images to the Face Recognition processor undergo feature extraction, yielding an image signature or template. If the image is an Enroll (Reference image) the image's template is typically stored in a Template Reference Database. If the image is a test image, its template is compared with at least one template in the Template Reference Database and a score (a.k.a. authentication score) is associated with each match, Depending on the decision algorithm, the match with the highest score may be compared to a pre-established threshold.

According to certain embodiments:

If the threshold is surpassed, the highest scoring match is positively authenticated, i.e. deemed (TRUE), in which case the original input image, e.g. test image, is typically fed e.g. via a switch S1, to the Anti Spoofing processor, typically together with the original image's authentication score. If the anti-spoofing processor deems the image a spoof, a NOT AUTHENTICATED message is posted. Only if the anti-spoofing processor determines that the image is not a spoof, an AUTHENTICATED message is posted.

If the threshold is not surpassed, the highest scoring match is deemed (FALSE) and a NOT AUTHENTICATED message is posted.

According to certain embodiments, the anti-spoofing processor operates if/only if a face is authenticated by a face recognition engine.

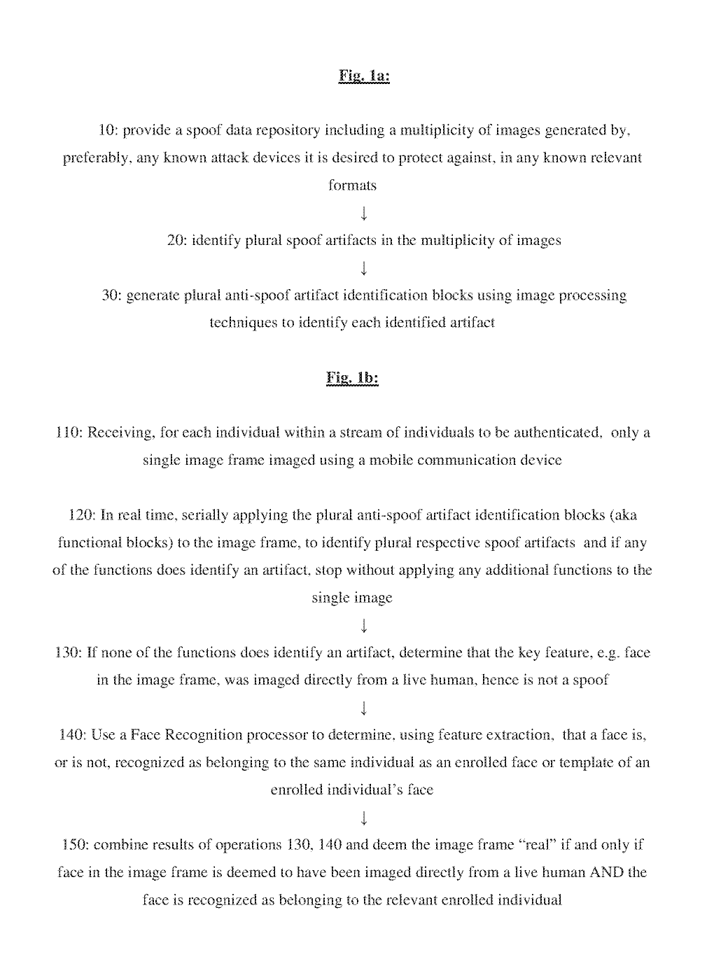

FIG. 1a is an example set-up method which may include some or all of the following operations, suitably ordered e.g. as illustrated:

10: provide a spoof data repository including a multiplicity of images generated by, preferably, any known attack devices it is desired to protect against, in any known relevant formats

20: identify plural spoof artifacts in the multiplicity of images

30: generate plural anti-spoof artifact identification blocks using image processing techniques to identify each identified artifact

FIG. 1b is an example method for normal anti-spoofing operation, which may include some or all of the following operations, suitably ordered e.g. as illustrated:

110: Receiving, for each individual within a stream of individuals to be authenticated, only a single image frame imaged using a mobile communication device

120: In real time, serially applying the plural anti-spoof artifact identification blocks (a.k.a. functional blocks) to the image frame, to identify plural respective spoof artifacts and if any of the functions does identify an artifact, stop without applying any additional functions to the single image

130: If none of the functions does identify an artifact, determine that the key feature, e.g. face in the image frame, was imaged directly from a live human, hence is not a spoof

140: Use a Face Recognition processor to determine, using feature extraction, that a face is, or is not, recognized as belonging to the same individual as an enrolled face or template of an enrolled individual's face

150: combine results of operations 130, 140 and deem the image frame “real” if and only if face in the image frame is deemed to have been imaged directly from a live human AND the face is recognized as belonging to the relevant enrolled individual

According to certain embodiments, artifacts may be identified by manual or computer-aided inspection of data repositories storing large numbers of spoofed images generated by various attack devices (such as but not limited to printed attacks, photo attacks, video attacks, 3d masks) in various formats.

The term “artifact” as used herein is intended to include or consist of any feature of an image, detectable by image processing, which is specific to spoofs e.g. occurs almost exclusively in spoofs and almost never in genuine images, and therefore can be used for anti-spoofing purposes without causing an unacceptable false detection rate. For example, an image feature may be considered an artifact if it causes an unacceptable false detection rate of less than 10% or less than 5% or less than 2% or less than 1% or less than 0.1% or less than 0.01%.

According to certain embodiments, all artifact detectors (aka identifiers, aka anti-spoofing functions or functional blocks, anti-spoof artifact identification blocks) employed are mutually orthogonal, to reduce aliasing error. Two functions f, g, are deemed orthogonal if their inner product is zero for f≠g. The inner product of functions f, g may be:)

[symbol]

f,g [symbol] =∫f(x)·g(x)dx

with appropriate integration boundaries. The asterisk signifies the complex conjugate of the function preceding the asterisk. Or, if approximating vectors \vec{f} and \vec{g} are created whose entries are the values of the functions f and g, sampled at equally spaced points, the inner product between f and g may be the dot product between approximating vectors \vec{f} and \vec{g}, at the limit as the number of sampling points goes to infinity.

The following example artifact detectors, all or any subset of which may be provided, are now described with reference to FIGS. 2-6:

Heuristic gradient detector detects the following artifact: edges of certain angles in a spoof image

Proximity detection detects 3d mask artifacts

Luminosity analyzer detects the following artifact: luminosity distributions characteristic of printed-2d-image-spoof attempts

Learning Block detects spoof artifacts learned from images deemed spoofs by other artifact identifying functions e.g. the artifact identifiers of FIGS. 2-4 and 6. The learning block identifies in such images (or templates derived from such images) artifacts other than the artifacts used to classify these templates as spoofs in the first place.

Oscillating patterns detects the following artifact: moiré patterns which are an artifact of video based spoofing attempts

It is appreciated that alternatively or in addition, artifacts other than those detected by the artifact detectors described below may be detected; and/or the artifacts detected by the artifact detectors described below may be detected in a different manner.

Referring now to FIG. 2, an example of a spoofing attack is an attempted breaching of a FA system by presenting a copy of biometric data of a legitimate user (either still image or video sequence playback) in front of a camera.

Pseudo-periodic image artifacts tend to occur when a video playback is shown to a FA system due to differences between two devices' characteristics. In a first phase the image is divided into fix-sized non-overlapping regions. Then, in an edge detector step, regions are labelled according to strong and medium edge areas.

In a second phase, only regions having medium intensity edges are selected to be further analyzed.

Statistical image measurements (such as grey-level co-occurrence matrix) are performed to extract feature vectors from specific areas detected in the first phase.

A final decision (real or attack input image) is then made, by feeding the feature vectors, to Lagrangian Support Vector Machine based classifiers.

Image artifacts include quality distortion of a video signal during digital encoding. One of the most common causes of these distortions is the aliasing phenomenon occurring when a signal is improperly sampled (especially at high frequency components). One frequent cause is given when the image is resized, leading to ringing around edge images. Another distortion could be caused by different frame rate leading to repeated lines superimposed over the image. Typically, when the scene information (details) cannot be accurately recorded distinctly by one pixel or another, image artifacts may occur either in the chrominance channel (moiré patterns) or in the luminance channel (maze artifacts). A particular case when oscillating patterns may occur is when a computer screen is photographed and the frame rate does not match the camera, as often occurs, leading to the phase synchronization issue commonly encountered with LCD screens. The RGB pattern on the LCD will interfere with the grid pattern of the sensor and create what is known as a maze pattern. Typically, the strength of these patterns is not constant over the whole image (some pixel values may be blended), or might be masked by complex texture contained in the original live scene.

If one compares a frame e.g. first frame of a video sequence recording a live face to a frame, e.g. first frame of video playback from the same scene with a iPhone mobile phone (low resolution) attack representing a nonlive face, it is apparent that, when photographing the screen, oscillating patterns occur (in the video attack). The patterns are particularly apparent if image patches from the same location are compared between the two frames: while oscillating patterns occur in the mobile attack, they are absent in the live face image. The appearance of these oscillating patterns is detectable particularly in the luminance channel.

Certain embodiments of the method herein include oscillating pattern detection for mobile video attack caused by the phase synchronization issue. A particular advantage is that unlike conventional video based methods that employ temporal information, only one frame for the spoof attack detection, as opposed several frames, is required, regardless of video length.

A method for oscillating patterns based detection of face spoofing attack in video replay is shown in FIG. 2 and may include some or all of the following operations, suitably ordered e.g. as shown:

610: data (facial images) acquisition procedure carried out in unconstrained setting without human monitoring; video replay spoofing may therefore occur

620: Smooth image areas are identified in the pixel domain which contain potential oscillating-like patterns.

630: image statistics are extracted

640: corresponding feature vectors are formed from the image statistics

650: detect oscillating patterns by classifying feature vectors as real or attack feature vectors e.g. using Lagrangian Support Vector Machines (LSVMs)

A possible implementation thereof, which may also be implemented as a variation thereof, is now described in detail.

Notation: A_{m×n}: Ω→ [symbol] , is used herein to denote a m×n graylevel (intensity) image, its elements |a|_{9i,j)}, i∈{1, . . . ,m}, j∈{1, . . . ,n}.

P_{k×l}^{s}⊂A_{m×n} is used herein to denote an image patch, with elements [p]_{(o,r)}, o∈{1, . . . ,k}, r∈{1, . . . ,l}, so that the set of all patches cover the whole image space as non-overlapping patches, i.e. the set of patches form a disjoint union, ␣_{s∈Q}P_{k×l}^{s}=∩_{s∈Q}{P_{k×l}²}, with q∈Q, s∈{1, . . . ,q}, and q=(m/k)×(n/l).

The method may include some or all of the following operations, suitably ordered e.g. as shown:

Operations 1-6 perform vertical oscillating patterns detection.
Operation 1) For each patch P_{k×l}^{s} do:
   Compute its corresponding binary image via the function BP_{k×l}^{s}=EdgeDetect(P_{k×l}^{s},thresh₁), where BP_{k×l}^{s}: Ω→{0,1}, and EdgeDetect is the function for image edge detection for a given threshold thresh₁;
   Compute the vertical profile (i.e. the sum on nonzero values indicating horizontal edges along the vertical axis) vector

$${VP}_{k \times 1}^{S} = {\sum }_{r = 1}^{l} {BP}_{k \times r}^{S}$$

corresponding to the binary image;
Pick up the peak profile, i.e. maxp^{s}=argmaxₖ{VP_{k×r}^{s}}.
Operation 2) Pick up the overall maximum peak value (among all patches s): ovpeak=argmaxₛ, {maxp^{S}}.
Operation 3) Select only the graylevel patches with peak values lower than a threshold thresh₂ of the overall peak value, i.e.: P_{k×l}^{w}, with w∈{s|s<thresh₂·ovpeak}, w∈{1, . . . ,ζ} and {1, . . . ,ζ} ⊂{1, . . . ,q}.
Operation 4) Compute vertical profile:
For each selected patch P_{k×l}^{w}
   Form the difference image (gradient image) along the vertical direction

$${VG}_{( k \times 1 ) \times l}^{w} = {\sum }_{o = 1}^{k - 1} \vert {P}_{o + 1 , l}^{w} - {P}_{o , l}^{w} \vert ,$$

and its mean

$${mVG}^{w} = \frac{1}{l \cdot ( k - 1 )} {\sum }_{r = 1}^{l} {\sum }_{o = 1}^{k - 1} {VG}_{o , l}^{w} ;$$

Perform histogram equalization on difference image eqVG_{(k-1)×l}^{w}=HistEq(VG_{(k-1)×l}^{w})
Compute the graylevel co-occurrence matrix

$${GLCM}_{u , v}^{w} = {\sum }_{r = 1}^{l} {\sum }_{o = 1}^{k - 1} I ,$$

where I is a function indicator such that

$$I = \{ \begin{matrix}1 , & if {eqVG}_{o , l}^{w} = u and {eqVG}_{o + Δ o , l + Δ l}^{w} = υ \\ 0 & otherwise ,\end{matrix} \qquad ( 1 )$$

where Δo and Δl are the vertical and horizontal distances respectively (offset) between the pixel-of-interest and its neighbor. In this case Δo∈{1, . . . ,k−1} is taken to capture the highest details and Δr=0, as a search is not performed in the horizontal axis;
Compute the GLCM correlation vector NCorr_{1×(k-1)}^{w} defined as

$${\sum }_{u = 1}^{{L}_{g}} {\sum }_{v = 1}^{{L}_{g}} \frac{( u - {μ}_{k - 1} ) \cdot ( v - {μ}_{l} ) \cdot {eqVG}_{u , v}^{w}}{{σ}_{k - 1} {σ}_{l}} ,$$

where σₖ₋₁ and σₗ are the standard deviations, and L_{g} is the dimension of the co-occuurence matrix (i.e. the number of gray levels);
Compute min-max normalization into interval [−1, +1] and compute the zero crossing rate (ZCR). If the alternating sequence is defined as

tₒ^{w}(NCorr_{1,o+2}^{w}−NCorr_{1,o+1}^{w})x(NCorr_{1,o+1}^{w}−NCorr_{1,o}^{w})<0, ∀ ∈{1, . . . ,k−2},

then, the ZCR is described by

$${ZCR}^{w} = \frac{1}{k - 2} {\sum }_{o = 1}^{k - 2} F \{ {t}_{o}^{w} \} ,$$

where F is another indicator function so that F{tₒ^{w}}is 1 if its argument tₒ^{w} is true and 0 otherwise:
Let indz_{y}^{w}∈{k|F{tₒ^{w}}=1} a vector with its elements denoting the zero crossing positions. The positive-going and negative-going values contained in each zero crossing interval (ZCInt) are computed, yielding the vector PNG with png_{y}^{w}=(indz_{y+1}^{w}−indz_{y}^{w}), ∀ y∈{1, . . . ,Y−1}
Finally, the PNG standard deviation, i.e. stdPNG^{w} is computed.
Operation 5) For each selected image patch in operation 4, a 3-dimensional oscillating pattern. (OPP) feature vector is formed in the following order: OPF^{w}[ZCR^{w},stdPNG^{w},mVG^{w}], ∀_{w}∈{1, . . . ,ζ}.
Operation 6) To an end, the OPF^{w} vectors are sorted in descending order of their largest ZCR, so that, only the first OPF vector (corresponding to the highest ZCR) is considered and the associated patch is the one more likely to comprise oscillating patterns due to moiré or maze phenomenon.
Operation 7: Operations 1-6, as aforesaid, perform vertical oscillating pattern detection. Particularly, if horizontal oscillating patterns are suspected to occur, operations 1-6 may be repeated, except that in operation 4, a horizontal profile rather than a vertical profile is computed.

This will detect the horizontal oscillating patterns.

Typically, the edge detection filter (Operation 1) applied to each patch is operative to yield a first separation of smooth image patches from image regions with high density of strong edges. The edge threshold (thresh₁) may for example be set at half the maximum pixel value to guarantee that strong edges are detected, while medium or weak edges are omitted. At this point image patches with a low number of strong edges, i.e. smooth image areas, are of interest. To delineate between image patches with potential moiré or maze oscillating patterns and patches that might contain other image artifacts caused by improper digital sampling, for instance, the method typically looks for patches with smooth pixel values transition. While the undersampling issue may generate visible image artifacts mainly around strong edges, the sought-for oscillating patterns are medium intensity edge independent and may also appear in smooth regions. Moreover, patches with a large number of edges may correspond to complex texture area which might interfere with formation of these patterns, making their detection and separation more difficult. For each resulting binary patch, the vertical profile is typically computed and the peak value is picked up. Patches with large peaks correspond to strong horizontal edges. The horizontal profile, i.e. strong vertical edges, is typically dealt with as described above in operation 4, rather than at this point.

Once the vertical profile for all binary patches has been computed, patches with peaks lower than threshold thresh₂=40% of the maximum computed (ovpeak) in the previous operation are typically selected as candidates. The others are ignored for the next operation. The difference image emphasizes horizontal lines while shrinking the effect of vertical lines e.g. to stress lines corresponding to vertical oscillations. These patterns are more likely to correspond to searched oscillating patterns than to strong horizontal edges as the patches with strong horizontal edges were ignored in the previous operations by selecting a proper thresh₂.

Computing the mean value is facilitated because, for oscillating patterns area, the oscillating values tend to compensate each other, and the mean value computed over all values is low. Theoretically, for a pure constant background (the smoothest area) containing only visible oscillating patterns, this value would in fact be zero. The mean value may be used as an indicator: amongst all selected patches, the mean with the lowest value does not necessarily correspond to the best selected patch but the oscillating patterns patches have low mean value, which will represent a variable of the final feature vector. Although, by performing difference image local intensity variation along vertical direction is flattened, large global intensity variations (especially on the horizontal axis) may exist, affecting the accuracy of the overall process.

The texture of difference image may next be analyzed using the correlation factor of the gray-level co-occurrence matrix (GLCM) which measures the linear dependency among neighboring pixels. This measure is indicative of the relative position of those pixels with respect to each other in that texture.

Next, min-max normalization may be performed to guarantee zero crossing of the correlation vector. The normalized zero crossing rate (ZCR) has been found to be a more important indicator than others. For an oscillating pattern the ZCR tends to be high, as normalized zero crossings are more frequent than those corresponding to a natural image patch. This ZCR indicator may be used as another variable of the final feature vector. For computing the PNG standard deviation it should be noted that pure oscillations have low standard deviation (the number of positive and negative going values remains approximately constant for each zero crossing interval (ZCInt), while for masked oscillations (or pseudo-oscillation patterns) the number of positive (or negative) values for zero crossings within each ZCInt may greatly vary from one ZCInt to another.

Examples of utility of certain embodiments:

Experiments were performed using data sets from the REPLAY-ATTACK Corpus made available by the Idiap Research Institute, Martigny, Switzerland. The full face database comprises short video recordings of both live access and nonlive attack) attempts for 50 different subjects. Two different conditions were created for live face recording: a) controlled (artificial uniform and constant illumination conditions) and b) adverse (non-uniform background, natural light). For each subject, 15 seconds of video at 25 fps were recorded with a resolution of 320×240 pixels. Three attack scenarios were considered: (1) print (the operator displays printed hard copies of high-resolution digital photographs), (2) mobile (the operator displays photos and videos taken with the iPhone using the iPhone screen), and (3) highdef (the operator displays high resolution digital photos and videos using an iPad screen with resolution 1024×768 pixels). Each video was captured for about 10 seconds in two different modes: a) hand-based (holding the recording device in hands, allowing hand movements or shaking) and b) fixed-support (the device is placed upon a fixed support).

The phone attack database was considered for the nonlive samples. The first frame at each 3rd second was extracted for each video recording, resulting in 5 samples for each subject corresponding to the real (live face) video. As the real data set contains 60 videos (4 per subject), a total of 300 samples built the final training set. 80 videos are included in the test set for the real case, resulting in 400 samples. The number of corresponding (mobile) phone attack videos is 120 (altogether hand and fixed support), but the recording is shorter (4 samples per subject were extracted), yielding 240 (60×4—only video was extracted) samples for the attack scenario and training data. Summing, a total of 540 samples form the overall training data set. Similarly, for the test and mobile attack 160 videos are available, leading to a total of 320 samples (4 samples per subject from video attack only). Hence, the test data set comprises 720 samples (both real and attack). Mobile phone photo samples were excluded.

The method above was implemented in Matlab and applied for all image samples to form an oscillating pattern feature vector OPF for each image sample. While in the case of attack samples the feature vector tends to describe areas very close to pure oscillating patterns, the detected areas for live face rather resemble oscillating-like patterns. Each 320×240 pixel image sample (m=240, n=320) was divided into non-overlapping 60×64 pixels (k=240, 1=320) patches, resulting in a total of q=20 image patches covering the whole image space. For edge detection, a Canny edge detector was employed with thresh₁=0.5). Only ζ=13 out of 20 potential oscillating patches with medium or weak vertical edges were automatically selected. Among the 13 patches, only one corresponding to the highest ZCR value was further considered to represent the oscillating-like image patch, and the associated feature vector was retained. The extracted oscillating pattern feature vector is OPF[0.64,0.78,0.34]. This feature vector ultimately enters the SVMs.

Once the OPF vectors were computed to discriminate between real and attack images, a conventional (nonlinear) Lagrangian Support Vector Machines (LSVM) based classifier was employed. The proposed oscillating pattern feature extraction approach was compared to LBP and concentric Fourier based features (denoted in FIG. 7 by CFOURF) described in the prior art. Unlike the OPF where the whole image was used, the LBP and CFOURF operates only within the detected face region. The LVSM was trained on the training samples and tested on the test data according to the protocol. Reported results correspond to the optimum parameters of the LSVM; in particular, the polynomial kernel of 3rd degree for the OPF, the polynomial of degree 18 for the LBP and polynomial of degree 10 for the CFOURF. The areas under curve (AUC), False Acceptance Rates (FAR), False Rejection Rates (FRR), and the Half Total Error Rates (HTER) are shown in tabular form in FIG. 7. The results indicate that the method shown herein outperforms the other two methods. The False Rejection Rate for OPF was comparable to that obtained for LBP, the False Acceptance Rate was halved.

According to certain embodiments some or all of the following may be provided:
a. The method does not require a sequence of video frames and may even employ only a single still image captured from any video frame.
b. The method may be employed even if Moiré or noise patterns are stationary across frames (their statistics do not change over time).
c. The method does not assume that image artifacts (such as Moiré patterns) occur upon the whole scene since any assumption that these artifacts occur globally indeed in practice does not always hold, and would result in distorting the periodicity of the patterns analyzed in the Fourier domain, with consequent decrease in accuracy. Instead, according to certain embodiments, patches with potential image artifacts are searched over the whole scene but less than all patches e.g. only one patch (local analysis) satisfying some statistical rules is retained to the end.
d. A distinction is made (e.g. in the first phase) between actual image artifacts and similar texture-like patterns, since failing to do so may cause interference between texture patterns and image artifacts (noise) with similar distribution thereby hampering accurate detection of fake video samples. This may for example occur with vertical blocks where parts of the clouds near the neck may contain similar noise-like texture.
   A correlation vector augmented with min-max normalization and zero-crossing rate is employed, which is more robust a feature than, for example, Haralick descriptors from GLCM as used in the prior art.

It is appreciated that mobile video attack is just one instance of possible spoofing attacks which may be detected by detecting their respective artifacts, which are present in the spoof and absent in genuine images. In the example of a mobile video attack, phase synchronization causes specific image artifacts as described herein, when face video data is recorded with a certain device, then played back with different media. The image artifacts detection herein extracts any or all of three features characterizing the oscillating behavior in the pixel domain. This may be combined with a reliable classifier thereby to efficiently discriminate between a real live recording and a mobile video playback attack. The method above may replace or augment other state-of-the-art antispoofing functionalities.

FIG. 3 is an simplified flowchart illustration of a proximity detector operative to detect and crop a face and monitors its geometry relative to a pre-stored statistical model of a face. Faces which are statistically unlikely, given the stored model, are deemed to be spoofs.

Typically, the proximity detection function monitors the spoof process itself and determines an attack probability for each known attack. The function typically monitors receiving image facial location in 3D metrics vs the receiving camera, and compares the receiving image facial location to a local database of such geometries. Specific feature geometries are extracted from the receiving image. These geometries are compared to geometries extracted during set-up from a data repository of spoof attempts by different people and devices. The same 3d metrics are extracted from the stored spoof attempts, statistical norms are developed, and the geometries in the receiving image are compared with the statistical nomis to identify outliers which are deemed spoof.

FIG. 4 is an simplified flowchart illustration of a luminosity analyzer operative to map an input image's luminosity distribution, and is based on previously learned spoof luminosity statistics to determine a spoof attempt accordingly. Certain types of spoof attempts generate a recognizable luminosity signature in certain parts of the receiving image and this signature enables real images to be differentiated from spoofed images.

A database of such signatures over tens of thousands of spoof attempts by different people and devices is recorded, and the signatures are compared with the artifacts in the database in the receiving image.

FIG. 5 is an simplified flowchart illustration of a Learning Block which learns image templates deemed spoofs by other artifact identifying functions e.g. the artifact identifiers of FIGS. 2-4 and 6, and identifies therein additional artifacts other than the artifacts used to classify these templates as spoofs in the first place.

Any conventional two-factor authentication security process may be employed to provide the 2^{nd} factor code input.

Any suitable combinatorial logic may be employed, in which plural input states define output states/s related by pre-defined rules which are typically independent of previous states.

Model coefficients may be developed in set-up which may include off-line training of a reconstruction algorithm to yield a given behavioral system expectation as closely as possible. Typically, only the model coefficients are stored and a pre-configured computing module contains the model algorithm. During module runtime, the algorithm retrieves the model coefficients as per need.

Model parameters (a.k.a. coefficients) may for example include some or all of: face size, distance between eyes, facial texture, luminosity, contrast, color, face location within the total image, facial orientation relative to the total image, gender, age-related factor/s, facial expression factors, facial landmarks, outdoor/indoor parameters.

FIG. 6 is an simplified flowchart illustration of a heuristic gradient detector operative to detect artifactual edges found to be typical of spoofs, e.g. to detect borders which are angled e.g. are neither vertical nor horizontal, e.g. using a Hough transform. It is appreciated that any suitable edge detection algorithm may be employed alternatively or in addition e.g. Sobel, Canny, Prewitt, Roberts, or fuzzy logic methods.

The Heuristic Gradient Detector (HGD) may be based on the Hough transform (HT) configured to locate line-shaped patterns in a digital image as is known, see e.g. Duda, et al 1972, “Use Of The Hough Transform . . . ”, Comms. ACM 15, 11-15.

The HGD typically defines a mapping from the image points into an accumulator space (Hough space) where a decision is made. More precisely, the image is firstly binarized (edge detection) and the resulting image space is scanned to find evidence satisfying line equation parameters (image points that lie on the same line).

The collinear points in an image with co-ordinates (x, y) are typically related by their slope in and an intercept c according to:

y=m*x+c (1)

or

A*y+B*x+1=0 (2)

In homogenous form, where A=−1/c and B=m/c. Equation (2) just above can be seen as the equation of a line for fixed co-ordinates (x,y) or as the equation of a line for fixed parameters (A, B). Therefore, pairs can be used to define points and lines simultaneously.

The HT typically gathers evidence of the point (A, B) by considering that all the points (x, y) define the same line in the space (A, B). That is, if the set of collinear points {(xᵢ, yᵢ)} defines the line (A, B), then

A*y_{I}+B*xᵢ+1=0 (3)

or in Cartesian form as

c=−xᵢ*m+yᵢ (4)

To determine the line, values of the parameters (m, c) (or (A, B) in homogeneous form) that satisfy Equation (3) (or (4), respectively may be found, as is known in the art; note FIG. 5.14a in “Feature Extraction and Image Processing” By Mark Nixon et al, available from Amazon, depicts two collinear points while FIG. 5.14b) represents two lines with concurrent point (A, B).

All the collinear elements in an image may define dual lines with the same concurrent point (A, B) satisfying equation (3). The system described in (3) is overdetermined (more equations than unknown). To restrict the points to a feasible solution HT may search for potential solutions and count them into an accumulator array that stores the evidence votes), by tracing all the dual lines for each point (xᵢ, yᵢ). Each point in the trace typically increments an element in the array, thus the problem of line extraction is transformed into the problem of locating a maximum in the accumulator space. HGD results for a simple line and a wrench are known. Maxima may be detected corresponding to major longest lines.

An alternative method is to use polar HT. This typically parameterises a line by considering a point (x, y) as a function of an angle normal to the line, passing through the origin of the image. This is known in the art; see e.g. FIG. 5.16 in “Feature Extraction and Image Processing” By Mark Nixon et al, available from Amazon, with relations:

ρ=x cos(θ)+y sin(θ)

where θ is the angle of the line normal to the line in an image and ρ is the length between the origin and the point where the lines intersect. Equation (4) above can be re-written as

c=ρ/sin(θ)

m=−1/than(θ)

More generally, artifactual edges typical of spoofs (and other artifacts typifying spoofs) may initially be identified by inspection, even manual inspection, of large data repositories of spoofed images, preferably spoofs generated by mobile devices, to identify edges typical to spoofs, preferably to spoofs generated by mobile devices, and normally absent in images of faces (generated e.g. by mobile devices) which are not spoofs.

Image processing heuristics may then be generated to identify the edges in question without falsely identifying background edges found in data repositories of genuine images, typically genuine images generated by mobile devices. For example, heuristics may take into account the edge's length, angle and appearance.

Alternatively or in addition, heuristics may take into account, inter alia, the location of the identified edge relative to the face. For example, an edge below the face is more likely to be an artifactual edge indicative of a spoof whereas an edge above or to the right or left of the face is less likely to be an artifactual edge indicative of a spoof. So, a final decision determining that an edge is an artifactual edge indicative of a spoof (and hence determining that the image is a spoof) may assign positive weight to an edge below the face, and assign a less positive or zero weight to an edge above or to the right or left of the face.

Heuristics may be designed to avoid false identification of common background (non-face) features such as wall edges, door edges, window edges, shutter edges, picture-frame edges etc., as artifactual edges indicative of a spoof. The heuristic selected to identify artifactual edges indicative of a spoof may either be one which does not falsely identify common background (non-face) features or alternatively or in addition, candidate artifactual edges may be identified and then at least one common background (non-face) feature may be ruled out by discarding candidate artifactual edges which answer to a criterion typical of at least one common background (non-face) feature. For example, shutters typically generate edges which have a regular light-dark pattern; spoof edges do not. Background edges to the right and left of a face whose orientations and positions suggest that the edge to the right and edge to the left form a single edge in back of the face, suggest a background edge (such as a border of a picture-frame hanging on a wall in back of the person whose face was imaged, or a window or shutter positioned on that wall) and not an artifactual edge indicative of a spoof.

These Artifactual edges may be a result of two active devices involved in spoofing attempts which are each projecting an artifactual image of themselves onto the other. For example, rather than presenting his own face to his mobile device's camera's field of view for authentication, an impostor may present to his mobile device's camera's field of view, a 2d screen device bearing an image of the face of a person whom the impostor wishes to impersonate.

Alternatively or in addition, artifactual edges typical of spoofs may be identified by inspection, even manual inspection, of large data repositories of spoofed images generated by specific commonly used mobile devices, such as an iPhone, to identify edges typical to spoofs, generated by specific mobile devices. For example, an iPhone when used for spoofing may be found to generate soft edges.

Typically, attack devices project different patterns on a receiving device camera, resulting in a receiving image which has now a superposition of the attack image and a projection of the attack device. Special patterns reflected in an image on a receiver device attacked by another device are detected, e.g. using a Hough transformation function. Hough transform, known for identifying positions of arbitrary shapes, may be used to find imperfect instances of objects within a certain class of shapes e.g. by a voting procedure carried out in a suitable parameter space. Object candidates are therm identified by computing local maxima in an accumulator space explicitly constructed by conventional Hough transform algorithms.

The manner in which the patterns project onto the receiving device camera is typically device dependent, hence can be said to generate specific heuristics in the receiving image. In a set up phase, a data repository of thousands (say) of spoof attempts by different people for each of many available devices may be generated and the device-specific heuristics may then be identified manually and stored as patterns. Next, an image processing technique for computerized identification of the identified heuristic may be developed. During normal operation, these heuristics, if identified in an image e.g. by comparison to the stored patterns, are indicative of spoofing.

Use cases may include any variety of letting in authorized users in while keeping everyone else out, including impostors, using John Smiths own picture (photograph, picture on phone, or three-dimensional mask) to gain access, which is intended to be restricted to the real John Smith, to data or physical premises (e.g. passport-control gate, secured door, employee attendance clock at a workplace), or to obtain authorization, also intended to be restricted to the real John Smith.

Face recognition use cases include, but are not limited to, face recognition sensors e.g. cameras embedded in smart mobile devices, face recognition apps downloaded to smart devices, and face recognition based authentication via secure cloud-based services linked to a population of mobile devices.

It is appreciated that certain embodiments are advantageous relative to conventional authentication, because passwords are cumbersome: they are hard to remember, easily hacked hence provide insufficient security, and inconvenient to enter, even on a full-sized computer, and especially on a mobile device. In practice, most end-users enter a password into their apps only once, which is convenient, but completely unsafe, making Smartphones and tablets exceptionally poorly protected in practice, although they are carried everywhere, hence are easily lost, stolen or misappropriated. Authentication questions are also cumbersome: the end-user may be required, for each use of a mobile functionality, to expend several minutes answering questions about her or himself, as opposed to simply looking at her or his smartphone (at the camera on her or his mobile device) momentarily e.g. for a single second, which is useful for mobile handset manufacturers, digital wallets, and software developers, reduce or prevent the huge expenses and inconvenience engendered by identity theft, bank account takeovers, bank account hacks and other forms of fraud, and various inconveniences related to end users having to verify their identity. The system is also useful for reducing the number of times an impostor can succeed, per unit effort.

The system both analyzes a face, and verifies that the lighting behaves as would be expected on a face, as opposed to a non-face such as a (spoofed) 2d representation of a face. Either photos or masks of an end-user used to gain illicit access i.e. to score false positives, are typically handled by embodiments described herein.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required, or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMS. Components described herein as software may, alternatively, be implemented wholly or partly in hardware and/or firmware, if desired, using conventional techniques, and vice-versa. Each module or component may be centralized in a single location or distributed over several locations.

Included in the scope of the present disclosure, inter ilia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order; a computer program product comprising a computer usable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software, any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention, including operations, which are described in the context of separate embodiments, may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section or in publications mentioned therein.

Conversely, features of the invention, including operations, which are described for brevity in the context of a single embodiment or in a certain order, may be provided separately or in any suitable subcombination, including with features known in the art (particularly, although not limited to, those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1. An anti-spoofing system operative for repulsing spoofing attacks in which an impostor presents a spoofed image of a registered end user, the system comprising:
a plurality of spoof artifacts identifiers including a processor configured for identifying a respective plurality of spoofed image artifacts in each of a stream of incoming images; and
a decision maker configured to determine an individual image in the stream is authentic only if a function of artifacts identified therein is less than a threshold criterion.

2. A system according to any preceding claim wherein the function of artifacts comprises the number of artifacts identified.

3. A system according to claim 1 or 2 wherein the artifact identifier includes a heuristic gradient detector operative to detect at least one heuristic typical of spoof attempts.

4. A system according to any preceding claim wherein the artifact identifier includes proximity detection.

5. A system according to any preceding claim wherein the artifact identifier includes a lumiosity analyzer configured to map image luminosity distribution and to identify an artifact based on previously learned statistics regarding image luminosity distribution.

6. A system according to any preceding claim wherein the artifact identifier includes a Learning Block operative to learn a pattern of spoof attempts and capable to predict the next attempt type based on previously learned statistics.

7. A system according to any preceding claim wherein the artifact identifier includes an oscillating pattern detector operative to map moiré patterns characteristic of video based spoofing attempts.

8. A system according to claim 2 wherein the threshold criterion stipulates that an individual image in the stream is authentic only if no (zero) artifacts are identified therein.

9. A system according to any preceding claim wherein at least one spoof artifact identifier is configured to detect spoofed image artifacts present in plural images within a repository, in computer storage, of spoofed facial images.

10. A repository, in computer storage, of spoofed facial images generated using a mobile device to image a spoof of a human face rather than the human face itself.

11. A repository according to claim 10 which also includes facial images which are not spoofs.

12. A repository according to claim 10 which also includes facial images which are not generated using a mobile device.

13. A repository, in computer storage, of spoofed facial images generated in the wild.

14. A system according to claim 9 wherein at least some of said images are generated using a mobile device.

15. A system according to claim 9 wherein at least some of said images are generated in the wild.

16. An anti-spoofing method operative for repulsing spoofing attacks in which an impostor presents a spoofed image of a registered end user, the method comprising:
Providing a plurality of spoof artifact identifiers including a processor configured for identifying a respective plurality of spoofed image artifacts in each of a stream of incoming images; and
Determining an individual image in the stream is authentic only if a function of artifacts identified therein is less than a threshold criterion.

17. A system according to claim 7 wherein the oscillating pattern detector is configured to:
Identify smooth image areas which contain potential oscillating-like patterns and extract image statistics therefrom;
Form corresponding feature vectors from the image statistics; and
detect oscillating patterns by classifying feature vectors as real or attack feature vectors.

18. A system according to claim 17 wherein said oscillating patterns are detected using Lagrangian Support Vector Machines (LSVMs).

19. A computer program product, comprising a non-transitory tangible computer readable medium having computer readable program code embodied therein, said computer readable program code adapted to be executed to implement a method for anti-spoofing operative for repulsing spoofing attacks in which an impostor presents a spoofed image of a registered end user, the method comprising:
Providing a plurality of spoof artifact identifiers including a processor configured for identifying a respective plurality of spoofed image artifacts in each of a stream of incoming images; and
Determining an individual image in the stream is authentic only if a function of artifacts identified therein is less than a threshold criterion.
